(19) United States
(12) Patent Application Publication
(10) Pub. No.: US 2025/0367874 A1
(43) Pub. Date: Dec. 4, 2025

(54) PRODUCTS BUILT USING GAS GENERATING AGENTS

(71) Applicant: Peridot Print LLC, Palo Alto, CA (US)

(72) Inventors: Emre Hiro DISCEKICI, San Diego, CA (US); Dennis John SCHISSLER, San Diego, CA (US)

(21) Appl. No.: 18/875,151

(22) PCT Filed: Jun. 17, 2022
(86) PCT No.: PCT/US2022/073025

§ 371 Date: Dec. 15, 2024

(51) Int. Cl. B29C 64/165; B22F 10/38; B22F 10/85; B29C 64/188; B29C 64/386; B33Y 10/00; B33Y 30/00; B33Y 80/00

(52) U.S. Cl. CPC B29C 64/165; B22F 10/38; B22F 10/85; B29C 64/188; B29C 64/386; B33Y 10/00; B33Y 30/00; B33Y 80/00

(57) ABSTRACT

In some examples, an additive manufacturing process to build a human engageable product includes receiving a model representing the human engageable product to be built, the model containing information indicating spatial regions in the human engageable product with a physical property different than other spatial regions in the human engageable product. The additive manufacturing process further includes selectively applying a gas generating agent onto build material layers during the additive manufacturing process based on the information in the model, where the gas generating agent is applied to locations of the build material layers corresponding to the indicated spatial regions, and where the gas generating agent comprises a gas generating material that chemically reacts at a temperature to generate a gas.

### BACKGROUND

Additive manufacturing processes can be used to build various articles. As examples, the articles can include human wearable products such as footwear, gloves, clothing, splints, headwear, and so forth. As other examples, the articles can include products that are provided to support a user, such as seat cushions, child seats, mattresses, braces, splints, and so forth.

### BRIEF DESCRIPTION OF THE DRAWINGS

Some implementations of the present disclosure are described with respect to the following figures.

FIG. 1 is a block diagram of an additive manufacturing machine for building a human engageable product including pores formed from a gas generating agent, according to some examples.

FIG. 2 is a block diagram of a human engageable product that includes pores formed from a gas generating agent, according to some examples.

FIG. 3 is a flow diagram of a process of building a human engageable product including pores formed from a gas generating agent, according to some examples.

FIG. 4 is a block diagram of an additive manufacturing machine according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

As used here, a “human engageable product” can refer to any type of product that a human is to engage with, such as to wear, sit on, lie on, and so forth. Note that the human engageable product in some cases is not in direct contact with the skin of a user (e.g., there may be other layer(s) between the human engageable product and the skin of the user.

A specific example of a human wearable product is footwear, such as a shoe. A shoe can include an insole, which is a layer of material in the shoe that is provided to improve the fit of the user's foot in the shoe. In some examples, footwear can include an orthotics component (e.g., an orthotics insole) that can be customized to a user's foot. The orthotics insole can be designed by a podiatrist or another specialist for a given user. Another type of orthotic device can include an ankle foot orthotic (AFO), and so forth.

Other examples of human-wearable products include helmets, hats, gloves, braces to support different parts (e.g., lower back, knee, elbow, wrist, ankle, etc.) of a user, splints to support a user's injured limb, and so forth.

In further examples, human engageable products can include human support products such as seat cushions, child seats, mattresses, and so forth, on which a user can sit or lie upon.

Generally, a human engageable product can “support” a human or a part of a human if the human engageable product can hold the human (part) in place or otherwise makes contact with the human (part).

An issue associated with human engageable products is that in some cases, they can be relatively heavy. The weight can add to the discomfort of the user, such as when wearing the product. Also, heavier products can be less convenient to move around. In other cases, human engageable products can be too stiff or have other undesirable physical properties.

In accordance with some implementations of the present disclosure, a human engageable product can be built using an additive manufacturing process based on a model containing information indicating spatial regions in the human engageable product with a physical property (e.g., material density, stiffness, strength, porosity, etc.) that is different from other spatial regions in the human engageable product. The additive manufacturing process applies a gas generating agent on build material layers during the additive manufacturing process based on the information indicating the spatial regions with the different physical property.

For example, the physical property can be a material density. Spatial regions in the human engageable product that are indicated to have a lower material density can be spatial regions to which the gas generating agent is to be applied to produce pores. Spatial regions in the human engageable product that are indicated to have a higher material density can be spatial regions to which the gas generating agent are not to be applied (or where a smaller quantity of the gas generating agent is to be applied as compared to the spatial regions that have the lower material density).

As another example, the physical property can be a stiffness. Spatial regions in the human engageable product that are indicated to have a lower stiffness can be spatial regions to which the gas generating agent is to be applied to produce pores. Spatial regions in the human engageable product that are indicated to have a greater stiffness can be spatial regions to which the gas generating agent are not to be applied (or where a smaller quantity of the gas generating agent are to be applied as compared to the spatial regions that have the lower stiffness).

In some examples, the gas generating agent may be any material that chemically reacts at an elevated temperature to generate a gas. In some examples, the gas generating agent may be any material that reacts at an elevated temperature to generate multiple gaseous compounds.

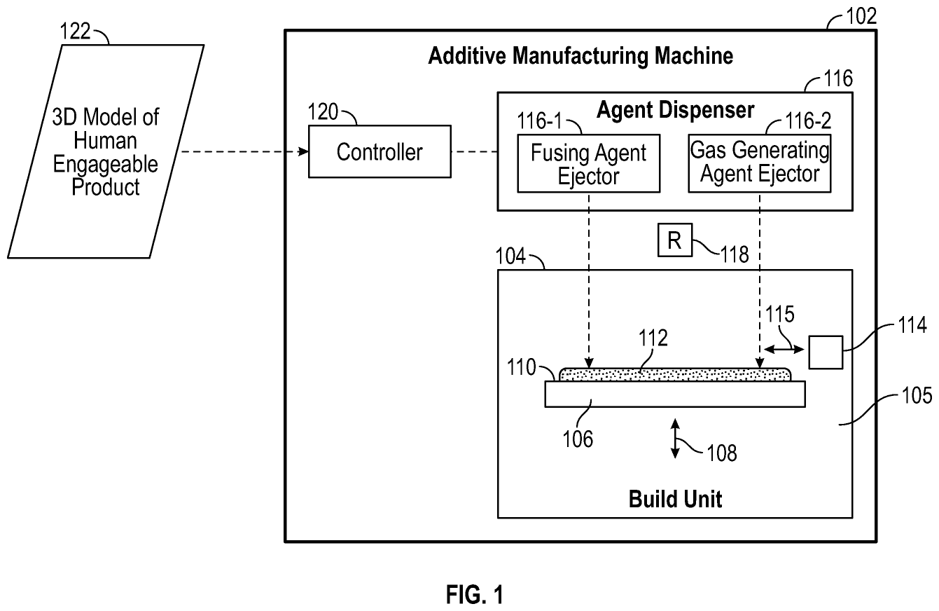

FIG. 1 is a block diagram of an example arrangement that includes an additive manufacturing machine 102, also referred to as a three-dimensional (3D) printer. The additive manufacturing machine 102 includes a build unit 104 providing a build chamber 105 in which a 3D object is built. In examples of the present disclosure, a 3D object that can be built by the additive manufacturing machine 102 is a human engageable product.

The build unit 104 may be removable from the additive manufacturing machine 102 in some examples. For example, the additive manufacturing machine 102 may be shipped from a manufacturer or a distributor without the build unit 104, and the build unit 104 may be added by a user after receipt of the additive manufacturing machine 102.

In the additive manufacturing machine 102, a build material (or multiple different build materials) can be used to form a 3D object, by depositing the build material(s) as successive layers until the final 3D object is formed. A build material can include a powdered build material that is composed of particles in the form of fine powder or granules. The powdered build material can include polymer particles, plastic particles, metal particles, or particles of other materials. The powdered form of the build material makes the build material free flowing in some examples.

Each layer of the build material is patterned into a corresponding part (or parts) of the 3D object, based on application of a liquid agent (or multiple liquid agents) to selected portions of the layer, followed by a further processing (e.g., heating) of the layer after the liquid agent(s) is (are) applied.

As shown in FIG. 1, the build unit 104 includes a build platform 106, which includes a support that is movable up and down in the directions along the axis 108 (e.g., a vertical axis in the view of FIG. 1). The build platform 106 can include an upper surface 110 on which a build material layer 112 can be spread by a spreader 114. The spreader 114 can be in the form of a blade, a roller, and so forth. The spreader 114 is moveable in directions along the axis 115 (e.g., a horizontal axis in the view of FIG. 1).

As each build material layer is processed, additional build material layers are formed on previously processed build material layers on the build platform 106.

Processing of a build material layer can include dispensing of liquid agents onto the build material layer from the agent dispenser 116. In addition, the additive manufacturing machine 102 can include a radiation source 118 (or multiple radiation sources) that emit radiation energy towards the build material layer to cause generation of heat in the build material layer as part of processing the build material layer.

In accordance with some implementations of the present disclosure, the agent dispenser 116 can dispense multiple different types of liquid agents, including a fusing agent and a gas generating agent according to some examples of the present disclosure. The fusing agent is dispensed by a fusing agent ejector 116-1 of the agent dispenser 116, and the gas generating agent is dispensed by a gas generating agent ejector 116-2 of the agent dispenser 116.

The agent dispenser 116 is moveable relative to the build unit 104 so that the fusing agent ejector 116-1 and the gas generating agent ejector 116-2 are moveable relative to the build platform 106.

Each of the fusing agent and the gas generating agent can be dispensed onto respective selected portions of the build material layer, based on control by a controller 120 of the additive manufacturing machine 102. The fusing agent and the gas generating agent can be dispensed onto some areas of the build material layer and are not dispensed onto the other areas of the build material layer. The controller 120 can control an operation of the fusing agent ejector 116-1 and the gas generating agent ejector 116-2 to control the locations where the fusing agent and the gas generating agent are to be dispensed onto each build material layer. The controller 120 can also control the movement of the agent dispenser 116 relative to the build unit 104, and the movement of the spreader 114 and the build platform 106.

The fusing agent can include water (or another liquid) and a radiation absorber. The radiation absorber of the fusing agent can absorb radiation emitted by the radiation source 118 and convert the radiation to heat. For example, the radiation source 118 can emit infrared energy or another type of energy. After applying the fusing agent from the fusing agent ejector 116-1 to the build material layer, the radiation source 118 can emit radiation that is absorbed by the fusing agent. Portions of the build material layer where the fusing agent is applied can heat up to a point that build material powders in the heated portions of the build material layer fuse together to form a solid part (or solid parts).

Additionally, the gas generating agent can also be applied to selected portions of the build material layer. Heat produced due to the presence of fusing agent in the build material layer can cause the gas generating agent to react and form a gas. In some examples, the gas can become trapped as small bubbles in the molten build material, such as a polymer. When the build material hardens, the bubbles can remain as pores within the build material matrix (e.g., a polymer matrix). The pores are voids that do not contain unfused build material powder, since the powder has been displaced from the pores.

In some examples, the areas of the build material layer where the gas generating agent is applied can be the same as, can overlap, or can be exclusive of the areas where the fusing agent is applied.

Since the gas generating agent is applied to selected areas of the build material layer, and not applied to other areas of the build material layer, a 3D part that is formed by processing the build material layer can have a porous portion and a non-porous portion.

The placement of liquid agents, including the fusing agent and the gas generating agent, by the agent dispenser 116 on selected portions of each build material layer in the build unit 104 is controlled by the controller 120 based on a 3D model 122 of the product to be built that includes porous portions formed using a gas generating agent.

Although reference is made to the agent dispenser 116 dispensing the fusing agent and the gas generating agent, it is noted that in further examples, the agent dispenser 116 can dispense additional liquid agents for use in building a human engageable product.

As an example, another type of liquid agent that can be applied during an additive manufacturing process is a detailing agent, which includes a material that can reduce a temperature of build material portions where the detailing agent is applied. In some examples, the detailing agent can be applied around edges of an area where the fusing agent is applied. This can prevent the build material layer around the edges from caking due to heat from the area where the fusing agent was applied. Caking is caused by heat conduction from a first build material powder portion in the build material layer to a second build material powder portion in the build material layer that may result in the second build material powder portion clumping or sticking together due to the second build material powder portion experiencing a higher temperature than the rest of the build material powder in the build material layer. To help mitigate this effect, the detailing agent is used for cooling purposes.

The detailing agent can also be applied in the same area as the fusing agent to control the temperature and prevent excessively high temperatures.

In accordance with some implementations of the present disclosure, a 3D object built by the additive manufacturing machine 102 is based on a 3D model 122, which can be a 3D model of a human engageable product with porous portions to be formed using the gas generating agent according to some examples.

Porous portions formed in the human engageable product using a gas generating agent according to some examples can affect certain properties of the human engageable product, including reducing the weight of the human engageable product, and/or reducing a strict stiffness or changing the strength of the human engageable product, and so forth.

By controlling the amount of the gas generating agent dispensed to selected portions of each build material layer that forms a human engageable product, the extent of porosity can be controlled. The “extent of porosity” in the human engageable product can refer to a density of pores in the human engageable product, for example. The extent of porosity can be adjusted by changing the amount of the gas generating agent that is applied to each build material layer. For example, applying a greater amount of the gas generating agent to areas of a build material layer can result in a greater quantity (e.g., greater density) of pores formed in a 3D part. As an example, if it is assumed that a part of the human engageable product is at a target density without the application of the gas generating agent, then the density of the part of the human engageable product after the application of the gas generating agent may be less than or equal to 90%, or 80%, or 70%, or 60%, or 50%, or 40%, or 30%, and so forth, of the target density.

In further examples, the extent of porosity can be adjusted by changing the amount of heating provided to the gas generating agent. Applying greater heat to the gas generating agent can cause a reaction of the gas generating agent that produces more gas, thereby increasing the quantity (e.g., density) of pores formed in a 3D part.

The 3D model 122 can be according to any of various formats, such as a Standard Triangle Language (STL) file or other computer aided design (CAD) formats. An STL file can use a series of linked triangles to represent surfaces of the 3D object to be built by the additive manufacturing machine 102.

The 3D model 122 can define the 3D shape of the human engageable product, and the 3D shape of porous portions to be formed in the human engageable product. In other examples, the overall human engageable product can be defined by a first 3D model, and the porous portions of the human engageable product can be defined by a second 3D model.

More generally, the 3D model 122 contains information indicating spatial regions in the human engageable product with a physical property different than other spatial regions in the human engageable product.

In some cases, the 3D model 122 contains information specifying that a physical property can vary continuously as a function of location in a 3D object to be build. As a result, varying amounts of the gas generating agent per unit volume may be applied in response to this information. In this way, varying levels of density, stiffness, or another physical property can be provided within the same 3D object.

The 3D model 122 can also include other information, such as information pertaining to materials to be used to form respective portions of the human engageable product, colors of respective portions of the human engageable product, or other properties of respective portions of the human engageable product.

In some examples, the 3D model 122 can also include information related to liquid agents to be applied on portions of a build material when building the human engageable product. For example, the information can specify a target quantity of a specific liquid agent (e.g., a gas generating agent, and/or a fusing agent, and/or a detailing agent) to be applied to a given space (e.g., a collection of voxels) of the human engageable product. A voxel represents a value (or a collection of values) in a unit of volume in a 3D space. The value(s) of the voxel can represent a property (or multiple properties) of a material or another characteristic in the unit of volume.

The information related to liquid agents can be in the form of a droplet saturation, for example, which can the controller 120 of the additive manufacturing machine 102 to eject a certain quantity of droplets of a liquid agent (e.g., a gas generating agent, and/or a fusing agent, and/or a detailing agent) onto a specific area. This can allow the controller 120 to finely control radiation absorption (based on dispensing of the fusing agent at target locations), cooling (based on dispensing of the detailing agent at target locations), and/or pore formation (based on dispensing of the gas generating agent at target locations).

The information related to liquid agents can be contained in a single 3D model or can be contained in multiple files.

Building a human engageable product based on a 3D model (e.g., 122) can refer to building the human engageable product based on a single 3D model or multiple 3D models, and further based on any further information (e.g., information related to liquid agents) that may be stored in a file (or multiple files).

In some examples, the controller 120 can execute a slicing program (including machine-readable instructions) to form, from the 3D model, slices that represent respective horizontal layers of the human engageable product. In other examples, the slicing program is executed on a computer external of the additive manufacturing machine 102. In the latter example, the slices can be sent by the computer to the additive manufacturing machine 102. The slices created by the slicing program correspond to build material layers in the additive manufacturing machine 102 that are processed in sequence to build the human engageable product. The slices can be in a g-code format or another format that defines instructions for the controller 120 of the additive manufacturing machine 102 for building a 3D object. In some examples, the slices are two-dimensional (2D) images that are printed. Each slice corresponds to a physical layer with a thickness and contains information to generate appropriate liquid agent quantities to produce a layer with target properties. In some examples, the information contained in the slices for the different layers are not uniform.

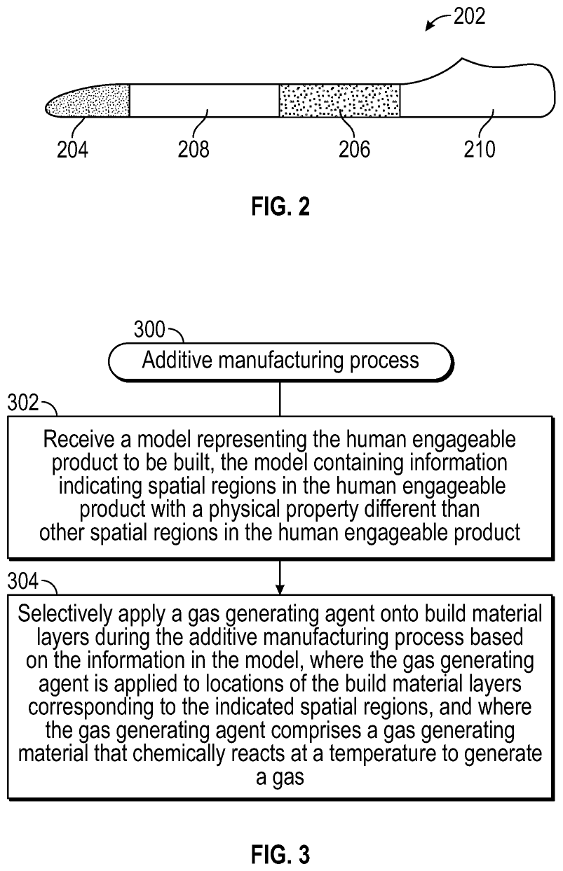

FIG. 2 is a schematic diagram of an insole 202, which is an example of a human engageable product. The insole 202 can be placed in a shoe to provide support for a user's foot.

The insole 202 can be built using the additive manufacturing machine 102 of FIG. 1. In the example of FIG. 2, the insole 202 has porous portions 204 and 206, and non-porous portions 208 and 210. The porous portions 204 and 206 includes pores formed by gas generated due to a reaction of the gas generating agent (ejected onto selected areas of build material layers) due to application of heat by the additive manufacturing machine 102. The gas generating agent is not dispensed onto areas of the build material layers corresponding to the non-porous portions 208 and 210. In the example of FIG. 2, the porous portion 206 is less dense (in terms of a build material) than the porous portion 204, which is accomplished by applying a greater amount of the gas generating agent to portions of build material layers corresponding to the porous portion 206 as compared to the amount of the gas generating agent applied to portions of build material layers corresponding to the porous portion 204. In further examples, the density of build material can be continuously varying, which can be formed by continuously varying amounts of the gas generating agent applied to parts of the insole 202 during the build operation.

In some examples, for example, the non-porous portion 208 corresponds to locations of the balls of the user's foot, and the non-porous portion 210 corresponds to the heel of the user's foot. The non-porous portions 208 and 210 of the insole 202 are subjected to greater forces, due to the majority of the user's weight being placed in these portions. On the other hand, less force is applied to the porous portion 204 (which corresponds to the locations of the toes of the user's foot) and the non-porous portion 206 (which corresponds to the arch of the user's foot).

Since the non-porous portions 208 and 210 are exposed to greater forces, the non-porous portions 208 and 210 do not include pores formed using the gas generating agent according to some examples of the present disclosure. However, the porous portions 204 and 206 can include pores formed using the gas generating agent to reduce the density of material in the porous portions 204 and 206, which can reduce the weight of the insole 202, and/or can reduce stiffness of the insole 202, which can enhance user comfort.

More generally, a human engageable product such as that depicted in FIG. 2 includes a portion (e.g., 204 or 206) including pores formed by gas generated by a reaction of the gas generating agent dispensed onto build material layers during building of the human engageable product by an additive manufacturing machine. A quantity of the pores is based on a model (e.g., the 3D model 122) representing the human engageable product containing information indicating spatial regions in the human engageable product with a physical property different than other spatial regions in the human engageable product, where the pores are in the indicated spatial regions.

In some examples, as noted above, the gas generating agent chemically reacts at an elevated temperature to generate a gas. In some examples, the gas generating agent may be selected from carbohydrazide, urea, a urea homologue, a carbamide-containing compound, a carbonate (e.g., ammonium carbonate), a bicarbonate (e.g., sodium bicarbonate, potassium bicarbonate, or ammonium bicarbonate), a nitrate (e.g., ammonium nitrate), a nitrite (e.g., ammonium nitrite), and combinations thereof. As used herein, a “urea homologue” may be an alkylurea or dialkylurea, such as methylurea and dimethylurea. In some examples, the alkyl group in the alkylurea or dialkylurea may be a C1 to C6 alkyl group. These compounds can decompose to form a gas when heated to a decomposition temperature. In some examples, the gas can include ammonia and/or carbon dioxide.

In some examples, the gas generating agent can react to form a gas at a temperature that is reached during a 3D printing process. In some examples, the temperature at which the gas generating agent reacts can be from about 100° Celsius (C) to about 250° C., or from about 120° C. to about 200° C., or from about 130° C. to about 150° C., or from about 150° C. to about 250° C., or from about 190° C. to about 240° C., as examples.

In some examples, the temperature at which the gas generating agent reacts is at or below the melting or softening temperature of the build material particles, for example, polymer particles. For example, the temperature at which the gas generating agent reacts can be within 100° C., or within 75° C., or within 70° C., or within 50° C., or within 25° C., or within 20° C., or within 15° C., or within 10° C., etc., of the melting or softening temperature of the build material particles.

In some examples, the temperature at which the gas generating agent reacts is up to 100° C. below the melting or softening temperature of the build material particles, or up to 90° C. below, or up to 85° C. below, or up to 80° C. below, or up to 75° C. below, or up to 70° C. below, or up to 50° C. below, or up to 25° C. below, or up to 15° C. below, or up to 10° C. below the melting or softening temperature of the build material particles. In some examples, the temperature at which the gas generating agent reacts is at least 5° C. below the melting or softening temperature of the build material particles, for example, or at least 10° C. below, or at least 15° C. below, or at least 20° C. below, or at least 25° C. below, or at least 30° C. below, or at least 35° C. below, or at least 40° C. below, or at least 45° C. below, or at least 50° C. below, or at least 55° C. below, or at least 60° C. below, or at least 70° C. below the melting or softening temperature of the build material particles. In some examples, the temperature at which the gas generating agent reacts is from 5° C. to 100° C. below the melting or softening temperature of the build material particles, for example, or from 10° C. to 90° C. below, or from 15° C. to 85° C. below, or from 20° C. to 80° C. below, or from 25° C. to 75° C. below, or from 30° C. to 70° C. below the melting or softening temperature of the build material particles.

In some examples, the gas generating agent that is applied to a build material layer may react completely to form a gas when the build material is heated during fusing of the particles of the build material. In other words, all or nearly all of the gas generating agent can react to yield the gas. In some examples, a portion of the gas generating agent may react and another portion of the gas generating agent may remain unreacted. In some examples, from about 50 wt. % (percentage by weight) to about 100 wt. % of the gas generating agent may react, for example, or from about 60 wt. % to about 95 wt. %, or from about 70 wt. % to about 90 wt. % of the gas generating agent may react. The proportion of the gas generating agent that reacts may depend on the temperature to which the build material is heated, the length of time that the build material is held at that temperature, the total amount of radiation energy applied to the build material, and so forth. Accordingly, in some examples, the amount of radiation energy applied, the length of time that the build material is heated, the temperature reached by the build material, the amount of fusing agent applied to the build material and other variables may affect the extent of the reaction of the gas generating agent.

These variables can be controlled by the controller 120 during a 3D printing process to control the extent of gas formation produced by reaction of the gas generating agent.

Alternatively, the amount of gas generating agent applied to the build material can be changed by changing the concentration of a gas generating material in the gas generating agent. In some examples, the gas generating material can be present in the gas generating agent in an amount of at least about 1 wt. % of the total weight of the gas generating agent, for example, or at least about 5 wt. %, or at least about 10 wt. %, or at least about 15 wt. %, or at least about 20 wt. %, or at least about 25 wt. %, or at least about 30 wt. % of the gas generating agent. In some examples, the gas generating material can be present in the gas generating agent in an amount of up to about 30 wt. % of the total weight of the gas generating agent, for example, or up to about 25 wt. %, or up to about 20 wt. %, or up to about 15 wt. %, or up to about 10 wt. %, or up to about 5 wt. % of the gas generating agent. In some examples, the gas generating material can be present in the gas generating agent in an amount of from about 1 wt. % to about 30 wt. %, for example, or from about 5 wt. % to about 25 wt. %, or about 10 wt. % to about 20 wt. %, or about 10 wt. % to about 15wt. % of the gas generating agent.

In some examples, the gas generating agent also includes components to allow the gas generating agent to be jetted by an ejector (e.g., the ejector 116-2 of FIG. 1), which can be in the form of a fluid jet printhead. In some examples, the gas generating agent can include jettability imparting ingredients. Jettability imparting ingredients helps to improve drop ejection from the fluid jet printhead so that the gas generating agent is delivered to the intended location.

In some examples, the gas generating agent further includes a component selected from a liquid vehicle, a surfactant, a dispersant, an antimicrobial agent (e.g., biocides, fungicides, etc.), a viscosity modifier, a material for pH adjustment, a sequestering agent, a chelating agent, a preservative, and combinations thereof.

In some examples, the gas generating agent is soluble or dispersible in a liquid vehicle. In some examples, the liquid vehicle is water, an alcohol, an ether or a combination thereof. In some examples, the liquid vehicle, for example, an aqueous liquid vehicle, includes a co-solvent. In some examples, the liquid vehicle includes a co-solvent or co-solvents in an amount of from about 1 wt. % to about 50 wt. % of the total weight of the gas generating agent. In some examples, no co-solvent is present. The balance of the formulation can be purified water. In an example, the liquid vehicle can be predominantly water.

In some examples, the co-solvent may be a high boiling point co-solvent, for example, a co-solvent that boils at a temperature higher than the temperature of the build material during printing. In some examples, the high boiling point co-solvent has a boiling point above about 250° C. In some examples, the high boiling point co-solvent is present in the gas generating agent in an amount of from about 1 wt. % to about 15 wt. %, for example, or from about 5 wt. % to about 10 wt. %.

In some examples, the co-solvent is an organic co-solvent. The organic co-solvent may be aliphatic alcohol, aromatic alcohol, diol, glycol ether, polyglycol ether, lactam, caprolactam, formamide, acetamide, a long chain alcohol, or a combination thereof. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, lactams (e.g., C5 to C 10 lactams, such as 2-pyrrolidinone), N-alkyl caprolactams, unsubstituted caprolactams, both substituted and unsubstituted formamides, both substituted and unsubstituted acetamides, and the like. Specific examples of solvents that can be used include 2-pyrrolidinone, N-methylpyrrolidone, 2-hydroxyethyl-2-pyrrolidone, 2-methyl-1,3-propanediol, triethylene glycol, tetraethylene glycol, 1,6-hexanediol, 1,5-hexanediol and 1,5-pentanediol.

In some examples, the surfactant may be a non-ionic, cationic, and/or anionic surfactant. In some examples, the surfactant may be a non-ionic organic surfactant. In some examples, the surfactant can be present in an amount ranging from about 0.01 wt. % to about 5 wt. %.

In some examples, the surfactant may be an organic surfactant, for example, a non-ionic organic surfactant. In some examples, the surfactant may be an alkyl polyethylene oxide, alkyl phenyl polyethylene oxide, polyethylene oxide block copolymer, acetylenic polyethylene oxide, polyethylene oxide (di)ester, polyethylene oxide amine, protonated polyethylene oxide amine, protonated polyethylene oxide amide, dimethicone copolyol, substituted amine oxide, and the like. The amount of surfactant added to the gas generating agent may range from about 0.01 wt. % to about 20 wt. %. Suitable surfactants can include liponic esters such as Tergitol™ 15-S-12, Tergitol™ 15-S-7 available from Dow Chemical Company (Michigan), LEG-1 and LEG-7; Triton™ X-100; Triton™ X-405 available from Dow Chemical Company (Michigan); sodium dodecylsulfate; and Tegowet® 510 available from Evonik; secondary alcohol ethoxylates such as Tergitol™ 15-S-9 available from Sigma-Aldrich.

Examples of suitable antimicrobial agents include, but are not limited to, NUOSEPT® (Nudex, Inc., New Jersey), UCARCIDE™ (Union carbide Corp., Texas), VANCIDER (R.T. Vanderbilt Co., Connecticut), PROXEL® (ICI Americas, New Jersey), Acticide B20, Acticide M20, and combinations thereof.

In some examples, sequestering agents or chelating agents, such as EDTA (ethylene diamine tetra acetic acid), may be included to eliminate the deleterious effects of heavy metal impurities, and buffer solutions may be used to control the pH of the fluid. In some examples, the sequestering or chelating agents may comprise from about 0.01 wt. % to about 2 wt. % of the gas generating agent. Viscosity modifiers and buffers may also be present, as well as other additives to modify properties of the fluid as desired. Such additives can be present at from about 0.01 wt. % to about 20 wt. %.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylene-diamine tetra (methylene phosphonic acid), potassium salt; and combinations thereof. Methylglycinediacetic acid, trisodium salt (Na₃MGDA) is commercially available as TRILON® M from BASF Corp. 4,5-Dihydroxy-1,3-benzenedisulfonic acid disodium salt monohydrate is commercially available as TIRON™ monohydrate. Hexamethylene-diamine tetra (methylene phosphonic acid), potassium salt is commercially available as DEQUEST® 2054 from Italmatch Chemicals.

In some examples, the gas generating agent may include an anti-kogation agent, for example, oleth-3-phosphate, which is commercially available as CRODAFOST 03A or CRODAFOS™ N-3 acid from Croda.

In some examples, the gas generating agent may include a buffer, for example, 2-amino-2-(hydroxymethyl)-1,3-propanediol, which is commercially available as Trizma from Sigma-Aldrich.

FIG. 3 is a flow diagram of an additive manufacturing process 300 to build a human engageable product.

The additive manufacturing process 300 includes receiving (at 302) a model (e.g., the 3D model 122 of FIG. 1) representing the human engageable product to be built, the model containing information indicating spatial regions in the human engageable product with a physical property different than other spatial regions in the human engageable product.

In some examples, the physical property can include a material density, a stiffness, or strength.

The model can define the 3D shape of the human engageable product, and the 3D shape of porous portions to be formed in the human engageable product.

In an example, spatial regions in the human engageable product that are indicated to have a lower material density can be spatial regions to which the gas generating agent is to be applied to produce pores. Spatial regions in the human engageable product that are indicated to have a higher material density can be spatial regions to which the gas generating agent are not to be applied (or where a smaller quantity of the gas generating agent is to be applied as compared to the spatial regions that have the lower material density).

As another example, the physical property can be a stiffness. Spatial regions in the human engageable product that are indicated to have a lower stiffness can be spatial regions to which the gas generating agent is to be applied to produce pores. Spatial regions in the human engageable product that are indicated to have a greater stiffness can be spatial regions to which the gas generating agent are not to be applied (or where a smaller quantity of the gas generating agent are to be applied as compared to the spatial regions that have the lower stiffness).

The additive manufacturing process 300 includes selectively applying (at 304) a gas generating agent onto build material layers during the additive manufacturing process based on the information in the model, where the gas generating agent is applied to locations of the build material layers corresponding to the indicated spatial regions, and where the gas generating agent comprises a gas generating material that chemically reacts at a temperature to generate a gas.

By controlling the amount of the gas generating agent dispensed to selected portions of each build material layer that forms a human engageable product, the extent of porosity can be controlled. The extent of porosity can be adjusted by changing the amount of the gas generating agent that is applied to each build material layer. For example, applying a greater amount of the gas generating agent to areas of a build material layer can result in a greater quantity (e.g., greater density) of pores formed in a 3D part. In further examples, the extent of porosity can be adjusted by changing the amount of heating provided to the gas generating agent. Applying greater heat to the gas generating agent can cause a reaction of the gas generating agent that produces more gas, thereby increasing the quantity (e.g., density) of pores formed in a 3D part.

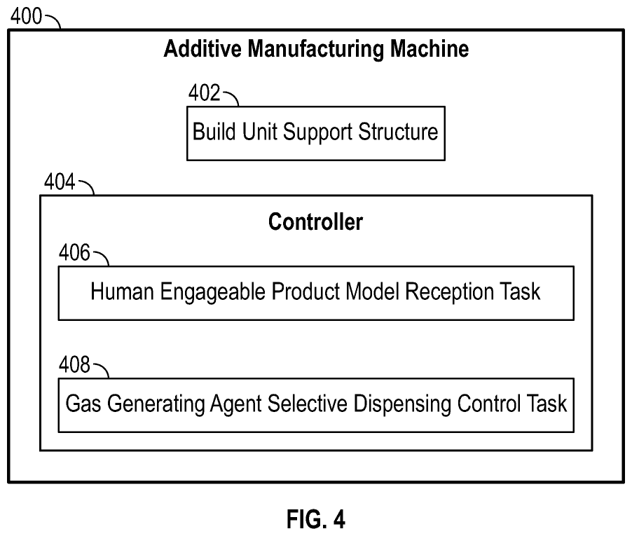

FIG. 4 is a block diagram of an additive manufacturing machine 400 according to some examples.

The additive manufacturing machine 400 includes a support structure 402 to receive a build unit (e.g., the build unit 104) in which a human engageable product is to be built. The support structure 402 can be a mounting structure to which the build unit 104 can be detachably mounted, an enclosure, or any other mechanical structure to receive the build unit 104.

The additive manufacturing machine 400 includes a controller 404 to perform various tasks, such as based on execution of machine-readable instructions. A “controller” can refer to a hardware processing circuit, which can include any or some combination of a microprocessor, a core of a multi-core microprocessor, a microcontroller, a programmable integrated circuit, a programmable gate array, or another hardware processing circuit.

The tasks of the controller 404 include a human engageable product model reception task 406 that receives a model representing the human engageable product to be built by the additive manufacturing machine, the model containing information indicating spatial regions in the human engageable product with a physical property different than other spatial regions in the human engageable product.

The tasks of the controller 404 include a gas generating agent selective dispensing control task 408 that controls an operation of an agent dispenser to selectively apply a gas generating agent onto build material layers during an additive manufacturing process based on the information in the model, where the gas generating agent is applied to locations of the build material layers corresponding to the indicated spatial regions, and where the gas generating agent comprises a gas generating compound that chemically reacts at a temperature to generate a gas.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method of building a human engageable product using an additive manufacturing process, comprising:
receiving a model representing the human engageable product to be built, the model containing information indicating spatial regions in the human engageable product with a physical property different than other spatial regions in the human engageable product; and
selectively applying a gas generating agent onto build material layers during the additive manufacturing process based on the information in the model, wherein the gas generating agent is applied to locations of the build material layers corresponding to the indicated spatial regions, and wherein the gas generating agent comprises a gas generating material that chemically reacts at a temperature to generate a gas.

2. The method of claim 1, wherein the human engageable product comprises a human wearable product.

3. The method of claim 1, wherein the human engageable product comprises a product to support a portion of a human.

4. The method of claim 1, wherein the physical property is a material density.

5. The method of claim 1, wherein the physical property is a stiffness.

6. The method of claim 1, wherein the physical property is strength.

7. The method of claim 1, comprising:
determining, by a controller of an additive manufacturing machine based on the model of the human engageable product, locations of the spatial regions indicated with the physical property different than the other spatial regions,
wherein the selective application of the gas generating agent is based on the determined locations.

8. The method of claim 1, wherein the human engageable product comprises an orthotics product.

9. The method of claim 1, comprising:
exposing the build material layers to energy, to cause heating of the gas generating agent to the temperature to generate the gas in the build material layers.

10. The method of claim 1, wherein the gas generating material is selected from carbohydrazide, urea, a urea homologue, a carbamide-containing compound, ammonium carbonate, ammonium nitrate, ammonium nitrite, or a combination thereof.

11. The method of claim 1, wherein the gas generating material comprises a liquid vehicle, a surfactant, an anti-kogation agent, a chelating agent or a combination thereof.

12. The method of claim 1, wherein the temperature at which the gas is generated is in a range of from about 100° C. to about 250° C.

13. A human engageable product comprising:
a portion comprising pores formed by gas generated by a reaction of a gas generating agent dispensed onto build material layers during building of the human engageable product by an additive manufacturing machine,
wherein a quantity of the pores is based on a model representing the human engageable product containing information indicating spatial regions in the human engageable product with a physical property different than other spatial regions in the human engageable product, wherein the pores are in the indicated spatial regions.

14. An additive manufacturing machine, comprising:
a support structure to receive a build unit in which a human engageable product is to be built; and
a controller to:
receive a model representing the human engageable product to be built by the additive manufacturing machine, the model containing information indicating spatial regions in the human engageable product with a physical property different than other spatial regions in the human engageable product; and
control an operation of an agent dispenser to selectively apply a gas generating agent onto build material layers during an additive manufacturing process based on the information in the model, wherein the gas generating agent is applied to locations of the build material layers corresponding to the indicated spatial regions, and wherein the gas generating agent comprises a gas generating material that chemically reacts at a temperature to generate a gas.

15. The additive manufacturing machine of claim 14, wherein the gas generating material is selected from carbohydrazide, urea, a urea homologue, a carbamide-containing compound, ammonium carbonate, ammonium nitrate, ammonium nitrite, or a combination thereof.
